(19) United States
(12) Patent Application Publication
(10) Pub. No.: US 2006/0114322 A1
(43) Pub. Date: Jun. 1, 2006

(54) Wide area surveillance system

(76) Inventors: John Frederick Romanowich, Skillman, NJ (US); Danny Chin, Princeton Junction, NJ (US)

Correspondence Address: MAYER & WILLIAMS PC, 251 NORTH AVENUE WEST, 2ND FLOOR, WESTFIELD, NJ, 07090, US

(21) Appl. No.: 10/999,802

(22) Filed: Nov. 30, 2004

(51) Int. Cl. H04N 7/18; H04N 9/47

(52) U.S. Cl. 348/143

(57) ABSTRACT

A vision system includes an image capturing arrangement for producing a plurality of first image signals of a scene based on electromagnetic energy received from the scene. A platform supports at least the image capturing arrangement for selectively positioning and repositioning the image capturing arrangement so that it images a series of different scenes. A memory is provided for storing scene-dependent parameters. At least one signal processor is operatively associated with the image capturing arrangement and the memory. The signal processor is configured to utilize at least one of the first image signals representing each of the scenes being imaged to adjust at least one image-capturing parameter to enhance image quality of the respective scene. The signal processor is also configured to utilize at least two of the first image signals received at different times that represent each of the scenes being imaged to generate, based on at least one predetermined criterion, a second image signal representing object motion arising in each of the scenes. The image-capturing parameter and the predetermined criterion are established on a scene by scene basis and stored in the memory for use by the signal processor upon imaging any given scene a subsequent time.

### FIELD OF THE INVENTION

The present invention relates generally to imaging systems and security cameras, and more particularly to an imaging system and security camera that obtains images by panning over a wide area.

### BACKGROUND OF THE INVENTION

Video surveillance or security cameras are a useful tool for enhancing safety in public and/or secure areas. A security camera allows activity to be monitored for alerting the occurrence of unwanted activity or intrusions, for identification, and/or for providing a signal that may be recorded for later reference or potential use as evidence.

The past few years have seen an increase in the integration of video camera and computer technologies. Today, the integration of the two technologies allows video images to be digitized, stored, and viewed on small inexpensive computers such as personal computers. Further, the processing and storage capabilities of these small inexpensive computers has expanded rapidly and reduced the cost for performing data and computationally intensive applications. Thus, video analysis systems may now be configured to provide robust surveillance systems that can provide automated analysis and identification for security and other purposes.

A conventional security system uses a video camera as the principal sensor and processes a resulting image to determine the presence or non-presence of an intruder or other potential threat. The fundamental process is to establish a reference scene known, or assumed, to have no intruder(s) present. An image of the present scene, as provided by the video camera, is compared with an image of the reference scene and any differences between the two scenes are ascertained. If the contents of the two scenes are markedly different, the interpretation is that an intrusion of some kind has occurred within the scene. Once the possibility of an intrusion is evident, the system and method operate to first eliminate possible sources of false alarms, and to then classify any remaining differences as being the result of a human or non-human intrusion.

The form of comparison between a past scene and the present scene is essentially a subtraction of the two scenes on a pixel by pixel basis. Each pixel, however, represents a gray level measure of the scene intensity that is reflected from that part of the scene. Gray level intensity can change for a variety of reasons, the most important being a new physical presence within a particular part of the scene. Additionally, the intensity will change at that location if the overall lighting of the total scene changes (a global change), or the lighting at this particular part of the scene changes (a local change), or the AGC (automatic gain control) of the camera changes, or the ALC (automatic light level) of the camera changes. With respect to global or local lighting changes, these can result from natural lighting changes or manmade lighting changes. Finally, there will be a difference of gray level intensity at a pixel level if there is noise present in the video.

While not insurmountable, the image processing required to perform intrusion detection with a stationary camera that monitors a given scene within its field of view presents challenging problems for all the aforementioned reasons. These problems become more intractable, however, when surveillance is required over large areas. For instance, places such as embassies, airports, seaports, borders, power plants, weapons depots, reservoirs, dams, ships, forward troop deployments, and perimeter security applications all need to be able to detect threats over large areas. Such locations require either multiple stationary cameras or a single camera that sweeps across the area undergoing surveillance. The former arrangement can quickly become prohibitively expensive to deploy and the large amount of information it provides can be difficult to adequately access. With the latter arrangement, the scene viewed by the camera is constantly changing, making it difficult to make frame by frame comparisons of the same scene.

### SUMMARY OF THE INVENTION

In accordance with the present invention, a vision system is provided that includes an image capturing arrangement for producing a plurality of first image signals of a scene based on electromagnetic energy received from the scene. A platform supports at least the image capturing arrangement for selectively positioning and repositioning the image capturing arrangement so that it images a series of different scenes. A memory is provided for storing scene-dependent parameters. At least one signal processor is operatively associated with the image capturing arrangement and the memory. The signal processor is configured to utilize at least one of the first image signals representing each of the scenes being imaged to adjust at least one image-capturing parameter to enhance image quality of the respective scene. The signal processor is also configured to utilize at least two of the first image signals received at different times that represent each of the scenes being imaged to generate, based on at least one predetermined criterion, a second image signal representing object motion arising in each of the scenes. The image-capturing parameter and the predetermined criterion are established on a scene by scene basis and stored in the memory for use by the signal processor upon imaging any given scene a subsequent time.

In accordance with one aspect of the invention, the signal processor is further configured to generate an alert based on one or more object-dependent criteria that is established on a scene by scene basis and stored in the memory for use by the signal processor upon imaging the given scene a subsequent time.

In accordance with another aspect of the invention, the image-capturing parameter is selected from the group consisting of integration time, offset, gain, and iris size.

In accordance with another aspect of the invention, the image-capturing parameter includes integration time, offset, gain, and iris size.

In accordance with another aspect of the invention, the image capturing arrangement comprises an element selected from the group consisting of a CCD arrangement, a CMOS arrangement, and a thermal imager.

In accordance with another aspect of the invention, an analog to digital converter is provided for transforming the plurality of first image signals to digital image signals.

In accordance with another aspect of the invention, the image capturing arrangement comprises a CMOS arrangement.

In accordance with another aspect of the invention, the platform comprises a pan/tilt unit.

In accordance with another aspect of the invention, at least one of the object-dependent criteria is time-dependent.

### BRIEF DESCRIPTION OF THE DRAWINGS

FIG. 1 shows a plan view of a surveillance camera that is arranged to pan over an extended area.

FIG. 2 shows a matrix of frames acquired by the camera as it sweeps over the four arc segments of the extended area shown in FIG. 1.

FIG. 3 shows a functional block diagram of one embodiment of a security camera constructed in accordance with the present invention.

### DETAILED DESCRIPTION OF THE INVENTION

The present inventor has recognized that image processing of video data from a single camera that pans over an extended area can be performed in a relatively simple and straightforward manner to extract meaningful information that is particularly useful in security applications. The image processing techniques referred to herein generally determine information about objects based on edge detection. Once an object edge (or edges) has been located, the objects can be recognized or identified based upon processes referred to herein as Computer Vision Detection (CVD) techniques. CVD techniques use object edges to detect inter-frame motion, scene changes that arise over time, and features of an object including but not limited to its' appearance, color, shape, size, texture, and the like.

As detailed below, in the present invention various parameters and criteria that are used by a security or surveillance camera system to determine the presence or absence of a threat are established on a scene by scene basis. That is, the parameters and criteria used to determine the existence of a potential security threat may differ from scene to scene. Appropriate parameters and criteria may be established when each scene is initially imaged, stored in memory and accessed for subsequent use when the camera returns to image the scenes at a later time. These parameters and criteria pertain to those employed to enhance the quality of the image that is acquired those used in the determination of object motion arising in a scene, and those used to determine if the nature and level of the motion or other activity is sufficient to warrant the generation of an alert indicative of abnormal behavior that could be a security threat.

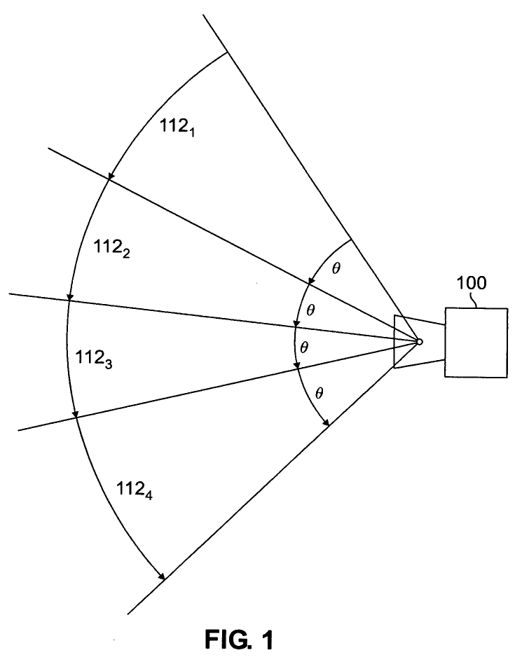

FIG. 1 shows a plan view of a surveillance camera that is arranged to pan over an extended area. Image acquisition may occur while the camera is panning or the camera may stop to capture an image before resuming motion. In either case, the present invention addresses the problem of how to process the data from multiple scenes to perform image processing. As shown, the field of view of the camera 100 extends over an angle θ and the area undergoing surveillance at any given time is represented by arc segments 112₁, 112₂, 112₃, and 112₄, each of which extend over the angle θ. Thus, each arc segment 1 12 denotes a scene to be imaged by the camera. Of course, the area undergoing surveillance is shown as being divided into four segments for illustrative purposes only and is not to be construed as a limitation on the invention.

For purposes of illustration only it will be assumed that the camera pans and stops at an orientation that allows it to obtain an image from each of the arc segments 112 in a sequential manner. That is, the camera is first oriented to obtain an image from arc segment 112₁, then the camera pans so that it is oriented to obtain an image from arc segment 112₂, and so on. The camera remains at each position for a sufficient length of time to obtain at least one frame of the scene being observed. It should be noted that while cameras generally acquire images in frames of video, the manner in which a frame is obtained will depend on the type of camera that is employed. However, regardless of camera type, each frame is exposed and immediately transferred away from the focal plane in which the image is formed, typically by a lens. For instance, in a video camera employing film, the frame rate is determined by a take-up reel that physically transfers the exposed film, typically at 30 frames per second. On the other hand, if the video camera employs a CCD, the image transfer is done electronically and the rate can be varied according to the application. The time required by the camera to collect light for imaging a single frame is often referred to as the integration time. The present invention is applicable to camera of all types regardless of the manner in which the image is acquired, provided that the digital representation of the image can be formed at some point so that image processing can be performed.

One problem that arises when a single camera is used to image multiple scenes is that the camera will typically need to be adjusted differently for each scene so that it is optimized to obtain the best possible image. Such adjustments are required because of scene-to-scene variations in lighting, differences in contrast among objects being observed and the like. Some exemplary parameters, referred to herein as image-capturing parameters, that may need to be adjusted to properly acquire an image include, without limitation, lens aperture, camera shutter speed, integration time and/or gain of the video amplifier. Since these parameters are continuously changing as the camera moves, frame by frame comparisons to determine object motion and the like become difficult to perform.

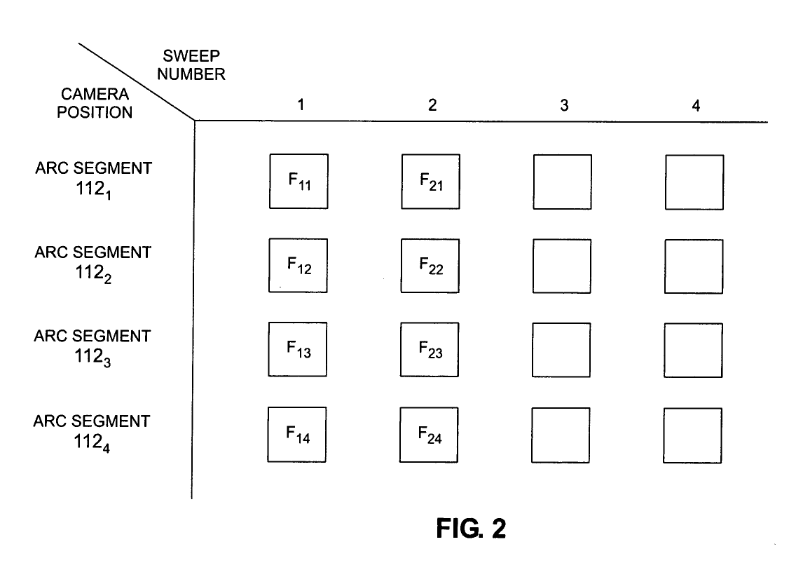

FIG. 2 shows a matrix of frames acquired by the camera as it sweeps over the four arc segments 112₁, 112₂, 112₃, and 112₄ shown in FIG. 1. Each column represents one sweep of the camera and thus includes four entries F₁₁, F₁₂, F₁₃, and F₁₄ corresponding to an image that is acquired from each arc segment 112 during that sweep. Thus, the first entry F₁₁ in the first column represents a frame of arc segment 112₁ during the first sweep, the second entry F₁₂ in the first column represents a frame of the arc segment 112₂ during the first sweep, and so on. Similarly, the second column represents the second sweep of the camera and includes four entries F₂₁, F₂₂, F₂₃, F₂₄ corresponding to an image that is acquired from each arc segment 112 during the second sweep.

In accordance with one aspect of the present invention, during the first sweep (or the first few sweeps) of the camera over the area being observed the camera adjusts its image-capturing parameters for each and every one of the arc segments it images. Presumably, the optimal values of the image-capturing parameters will differ from arc segment to arc segment. The camera stores the parametric values in a memory. Upon returning to a given arc segment during a subsequent sweep, the camera adjusts the parameters so that they return to the values that have been previously stored in memory for that segment. In this way inter-frame comparisons between frames acquired from the same scene during different sweeps of the camera (e.g., between frames F₁₁ and F₂₁ in FIG. 2) can be performed by appropriate image processing techniques to extract meaningful information such as object movement.

For simplicity of exposition each entry Fᵢⱼ in FIG. 2 has been hereinto for referred to as a single frame that is acquired by the camera. More generally, however, each entry may represent an average of multiple frames that the camera acquires while observing a given scene. That is, the camera may acquire multiple frames while it is oriented toward a given one of the arc segments 112.

The aforementioned technique allows different frames acquired from the same scene to be compared on a time frame that corresponds to the duration of each sweep of the camera. Comparisons can also be made on much shorter timescales if, as just mentioned, multiple frames are acquired from the same scene during the same sweep of the camera. In this way image processing techniques can be employed to compare different frames that are obtained over time intervals very nearly corresponding to the integration time of the camera.

In accordance with another aspect of the invention, in addition to improving the image-acquisition process by adjusting the image-capturing parameters on a scene by scene basis as discussed above, the present invention may also employ different criteria for different scenes during image processing to determine whether or not there has been any object motion in the scenes. These criteria, which will generally depend on characteristics of the particular objects in the scene, will hereinafter be referred to as “object-dependent criteria.” For example, if a given scene is known to contain a road carrying vehicular traffic, the criteria used to determine object motion may be different from those used in connection with another scene through which vehicular traffic does not normally pass. Other object-dependent criteria may be dependent on the type or size of object that is detected. For example, the motion of certain types of objects such as cars, boats and people, may be either monitored or ignored depending on the circumstances of a given scene. For instance, the motion of an object below a certain size may be assumed to be the motion of a bird and thus ignored.

In accordance with yet another aspect of the invention, the criteria used to generate an alert of a potential threat may be different from scene to scene. For example, in those scenes in which human activity is normally present, an alert will not be generated if the level of human activity falls within an expected range that is considered normal. In general, an alert will only be generated if the nature of the motion (e.g., speed and direction) that is detected is abnormal for the scene being imaged. Whether motion in any given scene is deemed abnormal will depend on a variety of factors, including in addition to speed and direction, the type of object undergoing motion, the time of day, and the like. In a particular scene, for example, it may be anticipated that individuals may be present on a walkway during the day but not at night. Likewise, it may be anticipated that a security guard may be walking out of a building but not into the building. Similarly, it may be anticipated that in a given scene delivery vehicles may arrive during certain portions of the day but not during other portions of the day. Accordingly, the criteria used to generate an alert will differ for scenes in which these different circumstances arise.

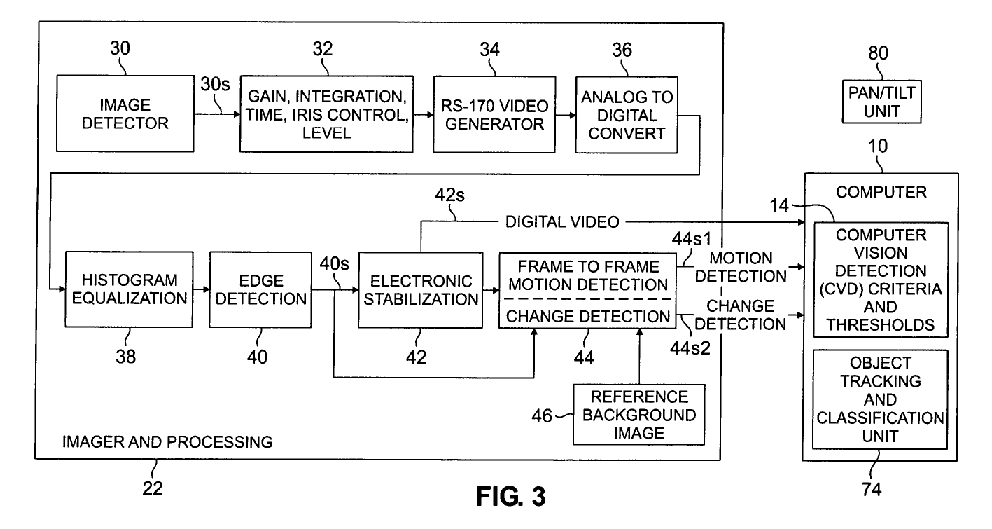

Referring now to FIG. 3, a functional block diagram of an exemplary security camera system constructed in accordance with the present invention is shown. The system includes camera 22, computer 10, and pan/tilt unit 80, all of which may be contained in the same assembly. Camera 22 produces an RS170 video signal as indicated by block 34. More recently developed cameras have digital outputs that would eliminate the need for A/D converters 36 since the signal would already be in a digital format.

The camera 22 can employ any video image capturing element 30 suitable to accumulate an image and output the image for further image processing. For example, the video image capturing element 30 may be a CCD, CMOS, thermal imagers or the like. The image capturing element 30 may also include other elements used to acquire an image such a lens, iris, zoom and focus controls, integrated optics package or other image acquisition devices.

Standard signal conditioning may be applied to the electronic signal 30s generated by image capturing element 30 to optimize the dynamic range of the electronic signal as a function of the level of electromagnetic radiation sensed. This may include adjusting integration time for the signal, and applying gain control, iris control, level control and non uniformity correction, as generally indicated at 32. As previously mentioned, in the present invention these image-capturing parameters may be adjusted for each scene imaged by the camera 22. The values of these parameters for a given scene are then stored for use when the camera subsequently returns to the given scene.

Returning to FIG. 3, the RS-170 video signal generated by RS-170 video generator 34 is processed by A/D converter 36. The resulting digital signal then undergoes additional signal processing such as histogram equalization, edge detection and electronic stabilization, which are indicated generally at 38, 40 and 42, respectively. Edge detector 40 may use, but is not limited to, wavelet decomposition or other well known edge detection techniques.

The conditioned signal 40s then is processed by object motion detector 44 to determine the edges of objects and their relative motion from frame to frame within the video image. In FIG. 3, the resulting signals are represented by signals 44s, and 44ₛ₂, which may generally be referred to as signal 44s. Motion detection schemes using edge detection, which are a subset of the aforementioned CVD techniques, are well known. For example, in the system disclosed in U.S. Pat. No. 5,272,527 a signal processing technique is applied to extract edges from an input image, noise reduction techniques are applied, and an averaging mechanism is used to binary threshold the incoming image data. The previous two binary images are retained and a series of logical operations are performed on these images to create a reference against which an incoming binary image is compared. In essence, the previous two frames are used to generate a reference mask (by inverting their union), and then a population count of binary ones is applied to the masked version of the incoming image. The result is an estimate of the difference between the incoming image and the previous two images. As another example, U.S. Pat. No. 6,493,041 discloses a method for detecting motion in which the pixels of each incoming digitized frame are compared to the corresponding pixels of a reference frame, and differences between incoming pixels and reference pixels are determined. A pixel difference threshold (that defines the degree in absolute value to which a pixel must vary from its corresponding reference pixel in order to be considered different) is used. Alternatively, a frame difference threshold (that defines the number of pixels which must be different for a motion detection indication to be given) is used. If the pixel difference for a pixel exceeds the applicable pixel difference threshold, the pixel is considered to be “different”. If the number of “different” pixels for a frame exceeds the applicable frame difference threshold, motion is considered to have occurred, and a motion detection signal is emitted.

As previously mentioned, in the present invention the criteria used to determine the presence or absence of object motion by object motion detector 44 may differ from scene to scene. The values of such criteria, which may include object speed and direction, are stored in a memory (such as CVD criteria unit 14 of computer 10) so that they can be used when the scenes are subsequently imaged by the camera. Likewise, the object-dependent criteria used to determine whether an alert should be generated may be stored in object tracking and classification unit 74 of computer 10

The aforementioned motion detection techniques are presented by way of illustration only and should not be construed as a limitation on the invention. Moreover, object motion detector 44 may employ other CVD techniques to further distinguish objects over time. For example, the object motion detector 44 can employ CVD techniques to learn more about the patterns, textures, shapes and appearances of objects in the scene being imaged. Among other benefits, these features can be used to distinguish naturally occurring objects or structures from man-made objects. For example, very straight, perfectly circular or orthogonal shapes generally do not readily occur in nature. Hence, vehicles and weapons can be recognized based upon the shapes or features inferred from the images that are acquired. In general, the present invention encompasses any technique for detecting edges, patterns, shapes and appearances over varying time intervals and is not limited to those techniques mentioned above.

Although various embodiments are specifically illustrated and described herein, it will be appreciated that modifications and variations of the present invention are covered by the above teachings and are within the purview of the appended claims without departing from the spirit and intended scope of the invention. For example, while the functional block diagram of FIG. 3 shows a variety of image processing functions being performed in the camera 22, these functions may instead be performed in any appropriate component such as computer 10. That is, the particular functional elements set forth in FIG. 3 are shown for purposes of clarity only and do not necessarily correspond to discrete physical elements. Moreover, the various image processing functions may be performed in hardware, software, firmware, or any combination thereof.

1. A vision system, comprising:
an image capturing arrangement for producing a plurality of first image signals of a scene based on electromagnetic energy received from the scene;
a platform supporting at least the image capturing arrangement for selectively positioning and repositioning the image capturing arrangement so that it images a series of different scenes;
a memory for storing scene-dependent parameters;
at least one signal processor operatively associated with the image capturing arrangement and the memory, said signal processor being configured to:
i. utilize at least one of the first image signals representing each of the scenes being imaged to adjust at least one image-capturing parameter to enhance image quality of the respective scene;
ii. utilize at least two of the first image signals received at different times that represent each of the scenes being imaged to generate, based on at least one predetermined criterion, a second image signal representing object motion arising in the each of the scenes; and
wherein said at least one image-capturing parameter and said at least one predetermined criterion are established on a scene by scene basis and stored in said memory for use by said at least one signal processor upon imaging any given scene a subsequent time.

2. The vision system of claim 1 wherein said at least one signal processor is further configured to generate an alert based on one or more object-dependent criteria that is established on a scene by scene basis and stored in said memory for use by said at least one signal processor upon imaging the given scene a subsequent time.

3. The vision system of claim 1 wherein said at least one image-capturing parameter is selected from the group consisting of integration time, offset, gain, and iris size.

4. The vision system of claim 1 wherein said at least one image-capturing parameter includes integration time, offset, gain, and iris size.

5. The vision system of claim 1 wherein said image capturing arrangement comprises an element selected from the group consisting of a CCD arrangement, a CMOS arrangement, and a thermal imager.

6. The vision system of claim 1 further comprising an analog to digital converter for transforming the plurality of first image signals to digital image signals.

7. The vision system of claim 1 wherein said image capturing arrangement comprises a CMOS arrangement.

8. The vision system of claim 1 wherein said platform comprises a pan/tilt unit.

9. The vision system of claim 2 wherein at least one of said one or more object-dependent criteria is time-dependent.

10. A vision system, comprising:
an image capturing arrangement for producing a plurality of first image signals of a scene based on electromagnetic energy received from the scene;
a platform supporting at least the image capturing arrangement for selectively positioning and repositioning the image capturing arrangement so that it images a series of different scenes;
a memory for storing scene-dependent parameters; and
at least one signal processor operatively associated with the image capturing arrangement and the memory, said signal processor being configured to generate an alert based on one or more object-dependent criteria that is established on a scene by scene basis and stored in said memory for use by said at least one signal processor upon imaging any given scene a subsequent time.

11. The vision system of claim 10 wherein said at least one signal processor is further configured to utilize at least one of the first image signals representing each of the scenes being imaged to adjust at least one image-capturing parameter to enhance image quality of the respective scene, wherein said at least one image-capturing parameter is established on a scene by scene basis and stored in said memory for use by said at least one signal processor upon imaging any given scene a subsequent time.

12. The vision system of claim 10 wherein said at least one signal processor is further configured to utilize at least two of the first image signals received at different times that represent each of the scenes being imaged to generate, based on at least one predetermined criterion, a second image signal representing object motion arising in the each of the scenes, wherein said at least one predetermined criterion is established on a scene by scene basis and stored in said memory for use by said at least one signal processor upon imaging any given scene a subsequent time.

13. The vision system of claim 11 wherein said at least one signal processor is further configured to utilize at least two of the first image signals received at different times that represent each of the scenes being imaged to generate, based on at least one predetermined criterion, a second image signal representing object motion arising in the each of the scenes, wherein said at least one predetermined criterion is established on a scene by scene basis and stored in said memory for use by said at least one signal processor upon imaging any given scene a subsequent time.
